(19) United States
(12) Patent Application Publication
(10) Pub. No.: US 2007/0218753 A1
(43) Pub. Date: Sep. 20, 2007

(54) String lamp assembly

(76) Inventor: Chin-Sung Tsai, Hsin-Chu Hsien (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/375,309

(22) Filed: Mar. 14, 2006

(51) Int. Cl. H01R 4/24

(52) U.S. Cl. 439/419

(57) ABSTRACT

A lamp assembly includes two juxtaposed electric cords, and a plurality of lamps each mounted on the electric cords. Each of the lamps includes a lamp holder, and a lamp cover. The lamp cover has an inside formed with two receiving grooves. Thus, the distal ends of the electric cords are received in the receiving grooves of the lamp cover to prevent the distal ends of the electric cords from being exposed outwardly. In addition, the lamp cover has a periphery formed with a plurality of flattened edges to define a plurality of gaps between the lamp cover and the lamp holder to provide water draining and air ventilating effects.

### BACKGROUND OF THE INVENTION

1. Field of the Invention The present invention relates to a lamp assembly and, more particularly, to a string lamp assembly having a string of lamps.

2. Description of the Related Art

A conventional string lamp assembly in accordance with the prior art shown in FIG. 8 comprises two juxtaposed electric cords 70, and a plurality of lamps (only one lamp is shown) each mounted on and electrically connected to the electric cords 70. Each of the lamps includes a lamp holder 72 mounted on the electric cords 70, two conducting plates (not shown) each mounted in the lamp holder 72 and each electrically connected to the respective electric cord 70, an electric bulb (not shown) mounted on the lamp holder 72 and electrically connected to the two conducting plates, and a lamp cover 74 mounted on the lamp holder 72 and rested on the electric cords 70 to clamp the electric cords 70 between the lamp cover 74 and the lamp holder 72.

However, the distal ends of the electric cords 70 are protruded from the lamp holder 72 and the lamp cover 74 of the last lamp, so that it is necessary seal and hide the distal ends of the electric cords 70 in the lamp holder 72, thereby increasing the volume of the lamp holder 72, and thereby causing inconvenience in assembly of the lamps. In addition, each of the lamps cannot provide water draining and air ventilating effects, thereby decreasing the lifetime and working efficiency of the lamp assembly.

### SUMMARY OF THE INVENTION

In accordance with the present invention, there is provided a lamp assembly, comprising two juxtaposed electric cords, and a plurality of lamps each mounted on and electrically connected to the electric cords. Each of the lamps includes a lamp holder mounted on the electric cords, and a lamp cover mounted on the lamp holder and rested on the electric cords to clamp the electric cords between the lamp cover and the lamp holder. The lamp cover has an inside formed with two receiving grooves to receive distal ends of the electric cords to prevent the distal ends of the electric cords from being exposed outwardly from the lamp holder and the lamp cover.

The primary objective of the present invention is to provide a lamp assembly, wherein the distal ends of the electric cords are received in the receiving grooves of the lamp cover so that the distal ends of the electric cords are entirely hidden in the lamp cover to prevent the distal ends of the electric cords from being exposed outwardly from the lamp holder and the lamp cover, thereby enhancing the aesthetic quality of the lamp assembly.

Another objective of the present invention is to provide a lamp assembly, wherein the distal ends of the electric cords are directly received in the receiving grooves of the lamp cover without occupying the space of the lamp holder, thereby reducing the volume of the lamp holder.

A further objective of the present invention is to provide a lamp assembly, wherein the lamp cover has a periphery formed with a plurality of flattened edges to define a plurality of gaps between the flattened edges of the lamp cover and the inner wall of the lamp holder so as to provide water draining and air ventilating effects, thereby enhancing the lifetime and working efficiency of the lamp assembly.

Further benefits and advantages of the present invention will become apparent after a careful reading of the detailed description with appropriate reference to the accompanying drawings.

### BRIEF DESCRIPTION OF THE DRAWINGS

FIG. 1 is a partially cut-away perspective view of a lamp assembly in accordance with the preferred embodiment of the present invention.

FIG. 2 is an exploded perspective view of the lamp assembly as shown in FIG. 1.

FIG. 3 is a plan cross-sectional view of the lamp assembly as shown in FIG. 1.

FIG. 4 is a partially exploded perspective view of the lamp assembly as shown in FIG. 1.

FIG. 5 is a perspective view of a lamp cover of the lamp assembly as shown in FIG. 1.

FIG. 6 is a top plan view of the lamp cover of the lamp assembly as shown in FIG. 1.

FIG. 7 is a bottom plan view of the lamp assembly as shown in FIG. 1.

FIG. 7A is a locally enlarged view of the lamp assembly as shown in FIG. 7.

FIG. 7B is a locally enlarged view of the lamp assembly as shown in FIG. 7.

FIG. 7C is a locally enlarged view of the lamp assembly as shown in FIG. 7.

FIG. 7D is a locally enlarged view of the lamp assembly as shown in FIG. 7.

FIG. 7E is a locally enlarged view of the lamp assembly as shown in FIG. 7.

FIG. 8 is an exploded perspective view of a conventional lamp assembly in accordance with the prior art.

### DETAILED DESCRIPTION OF THE INVENTION

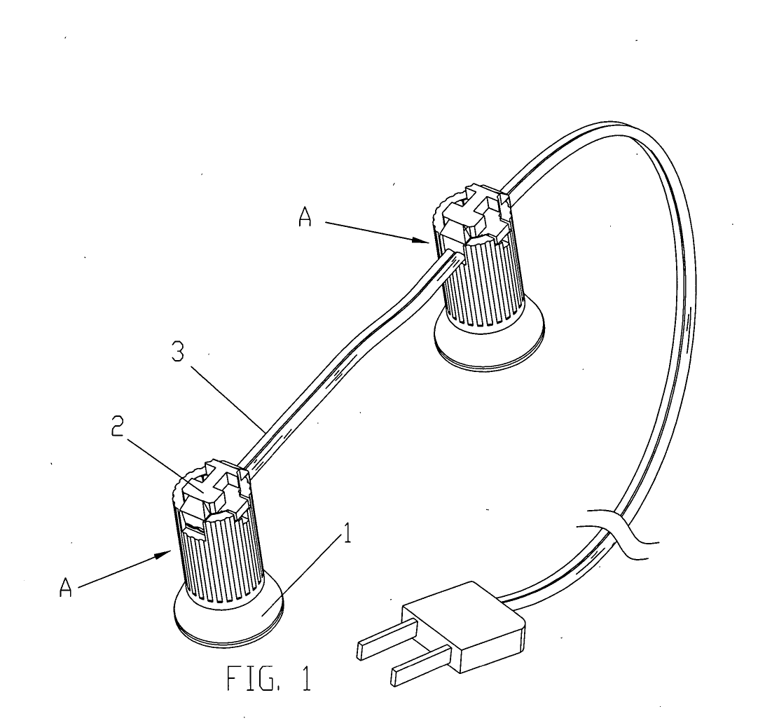

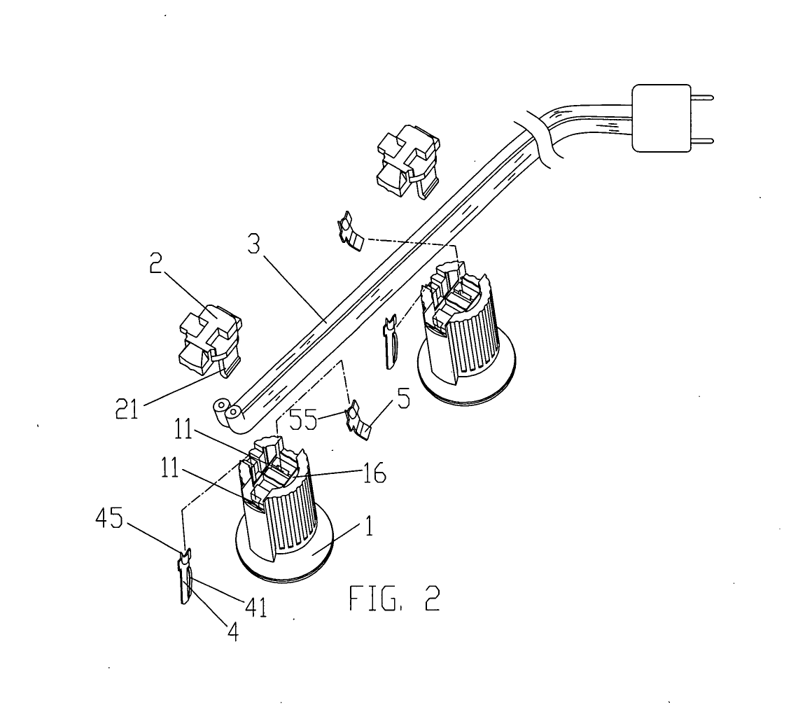

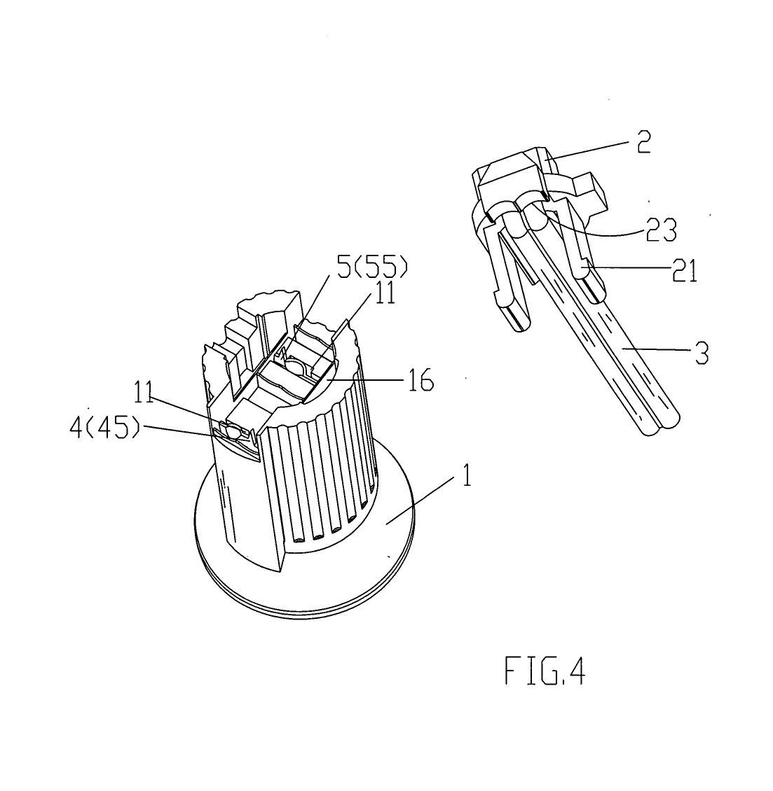

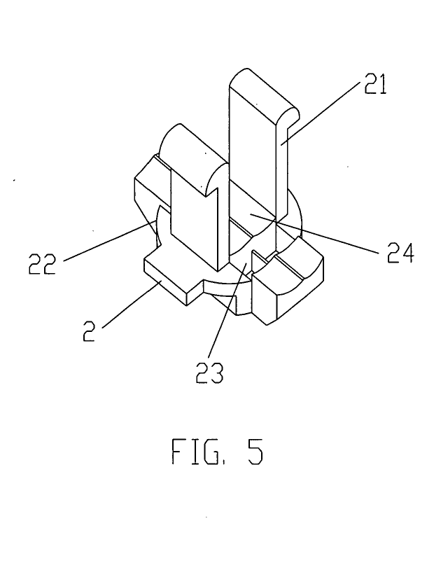

Referring to the drawings and initially to FIGS. 1-5, a lamp assembly in accordance with the preferred embodiment of the present invention comprises two juxtaposed electric cords 3, and a plurality of lamps “A” each mounted on and electrically connected to the electric cords 3.

Each of the lamps“A” includes a lamp holder 1 mounted on the electric cords 3, a first conducting plate 4 mounted in the lamp holder 1 and electrically connected to the respective electric cord 3, a second conducting plate 5 mounted in the lamp holder 1 and electrically connected to the respective electric cord 3, an electric bulb 6 mounted on the lamp holder 1 and electrically connected to the first conducting plate 4 and the second conducting plate 5, and a lamp cover 2 mounted on the lamp holder 1 and rested on the electric cords 3 to clamp the electric cords 3 between the lamp cover 2 and the lamp holder 1.

The lamp holder 1 is a cylindrical body and has two slots 11 to allow insertion of the first conducting plate 4 and the second conducting plate 5. The lamp holder 1 has two sides each formed with a locking recess 16.

The first conducting plate 4 is made of an elastic plate and has a substantially V-shaped cross-sectional profile. The first conducting plate 4 has a first side rested on the lamp holder 1 and a second side 41 rested on and electrically connected to the electric bulb 6. The first side of the first conducting plate 4 has a pointed connecting terminal 45 penetrated into and electrically connected to the respective electric cord 3.

The second conducting plate 5 is made of an elastic plate and has a substantially L-shaped cross-sectional profile. The second conducting plate 5 has a first side electrically connected to the respective electric cord 3 and a second side rested on and electrically connected to the electric bulb 6. The first side of the second conducting plate 5 has a pointed connecting terminal 55 penetrated into and electrically connected to the respective electric cord 3.

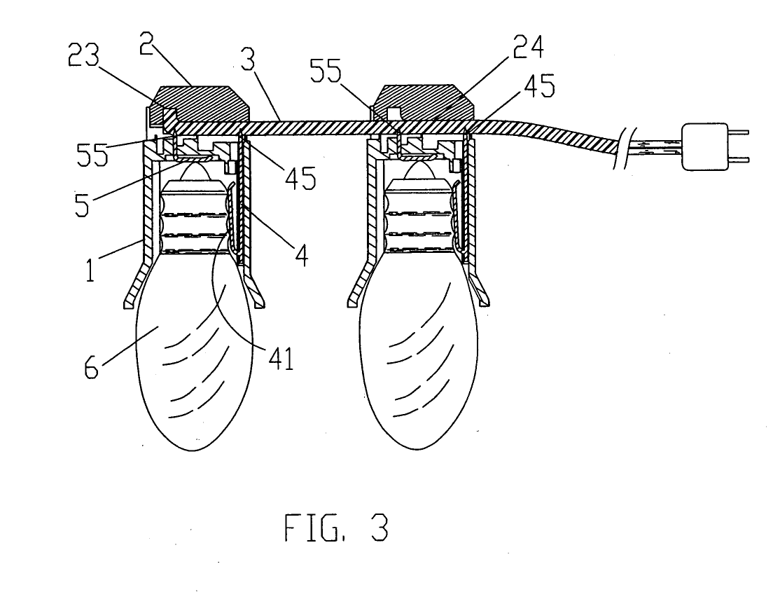

The lamp cover 2 has an inside formed with two receiving grooves 23 to receive distal ends of the electric cords 3 as shown in FIG. 3 to prevent the distal ends of the electric cords 3 from being exposed outwardly from the lamp holder 1 and the lamp cover 2. The lamp cover 2 has a bottom formed with a press plate 24 facing the connecting terminal 45 of the first conducting plate 4 and the connecting terminal 55 of the second conducting plate 5 and rested on the electric cords 3 to squeeze the electric cords 3 so that the connecting terminal 45 of the first conducting plate 4 and the connecting terminal 55 of the second conducting plate 5 are penetrated into and electrically connected to the electric cords 3. The lamp cover 2 is provided with two locking posts 21 each locked in the respective locking recess 16 of the lamp holder 1 to secure the lamp cover 2 to the lamp holder 1.

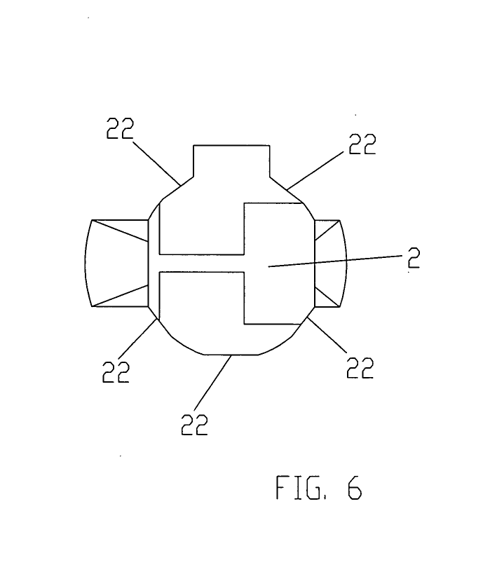

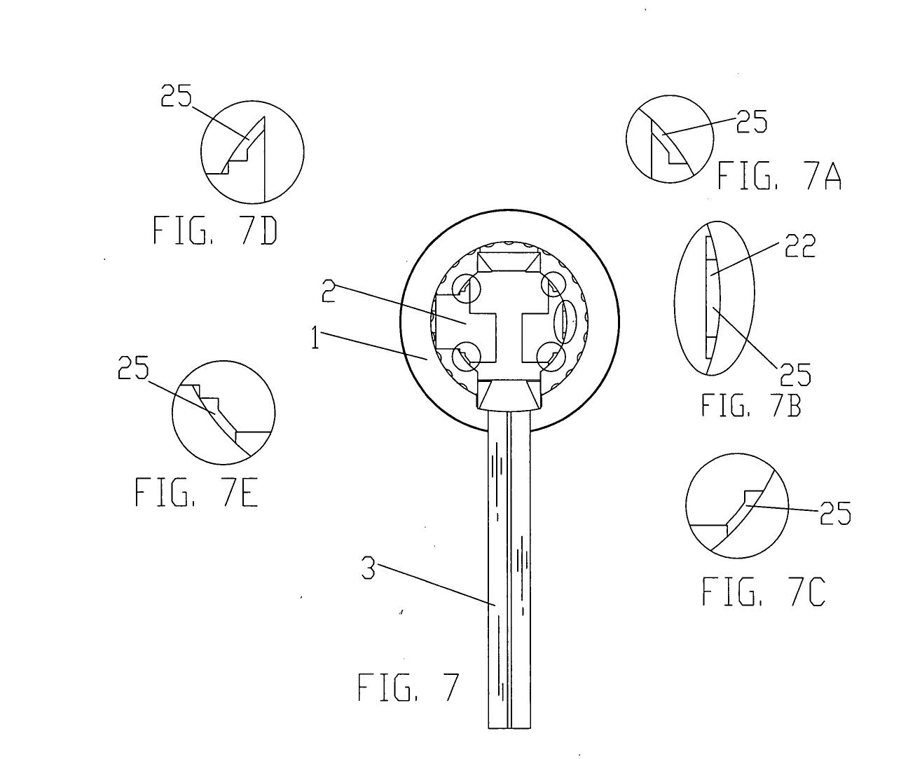

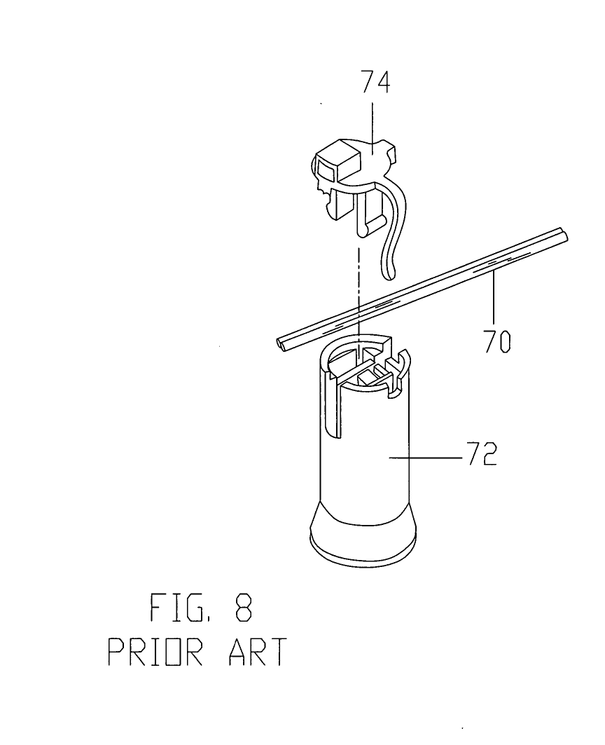

Referring to FIGS. 1-7, the lamp cover 2 has a periphery formed with a plurality of flattened edges 22 to define a plurality of gaps 25 between the flattened edges 22 of the lamp cover 2 and an inner wall of the lamp holder 1 as shown in FIGS. 7A-7E so as to provide water draining and air ventilating effects. Preferably, each of the flattened edges 22 of the lamp cover 2 has a straight shape.

Accordingly, the distal ends of the electric cords 3 are received in the receiving grooves 23 of the lamp cover 2 so that the distal ends of the electric cords 3 are entirely hidden in the lamp cover 2 to prevent the distal ends of the electric cords 3 from being exposed outwardly from the lamp holder 1 and the lamp cover 2, thereby enhancing the aesthetic quality of the lamp assembly. In addition, the distal ends of the electric cords 3 are directly received in the receiving grooves 23 of the lamp cover 2 without occupying the space of the lamp holder 1, thereby reducing the volume of the lamp holder 1. Further, the lamp cover 2 has a periphery formed with a plurality of flattened edges 22 to define a plurality of gaps 25 between the flattened edges 22 of the lamp cover 2 and the inner wall of the lamp holder 1 so as to provide water draining and air ventilating effects, thereby enhancing the lifetime and working efficiency of the lamp assembly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A lamp assembly, comprising two juxtaposed electric cords, and a plurality of lamps each mounted on and electrically connected to the electric cords, wherein:
each of the lamps includes a lamp holder mounted on the electric cords, and a lamp cover mounted on the lamp holder and rested on the electric cords to clamp the electric cords between the lamp cover and the lamp holder;
the lamp cover has an inside formed with two receiving grooves to receive distal ends of the electric cords to prevent the distal ends of the electric cords from being exposed outwardly from the lamp holder and the lamp cover;
the lamp cover has a periphery formed with a plurality of flattened edges located in an open end portion of the lamp holder to define a plurality of gaps between the flattened edges of the lamp cover and an inner wall of the open end portion of the lamp holder so as to provide water draining and air ventilating effects by the gaps.

2. (canceled)

3. The lamp assembly in accordance with claim 1, wherein each of the flattened edges of the lamp cover has a straight shape so that the flattened edges of the lamp cover form a polygonal profile and are rested on the inner wall of the open end portion of the lamp holder.

4. The lamp assembly in accordance with claim 1, wherein the lamp holder has two sides each formed with a locking recess which is located in an inside of the lamp holder, and the lamp cover is provided with two locking posts each inserted into the inside of the lamp holder and locked in the respective locking recess of the lamp holder to secure the lamp cover to the lamp holder.

5. The lamp assembly in accordance with claim 1, wherein each of the lamps further includes a first conducting plate mounted in the lamp holder and electrically connected to the respective electric cord, a second conducting plate mounted in the lamp holder and electrically connected to the respective electric cord, and an electric bulb mounted on the lamp holder and electrically connected to the first conducting plate and the second conducting plate.

6. The lamp assembly in accordance with claim 5, wherein the lamp holder has two slots to allow insertion of the first conducting plate and the second conducting plate.

7. The lamp assembly in accordance with claim 5, wherein the first conducting plate is made of an elastic plate.

8. The lamp assembly in accordance with claim 5, wherein the first conducting plate has a substantially V-shaped cross-sectional profile.

9. The lamp assembly in accordance with claim 5, wherein the second conducting plate is made of an elastic plate.

10. The lamp assembly in accordance with claim 5, wherein the second conducting plate has a substantially L-shaped cross-sectional profile.

11. The lamp assembly in accordance with claim 5, wherein the first conducting plate has a first side rested on the lamp holder and a second side rested on and electrically connected to the electric bulb, and the second conducting plate has a first side electrically connected to the respective electric cord and a second side rested on and electrically connected to the electric bulb.

12. The lamp assembly in accordance with claim 11, wherein the first side of the first conducting plate has a pointed connecting terminal penetrated into and electrically connected to the respective electric cord, and the first side of the second conducting plate has a pointed connecting terminal penetrated into and electrically connected to the respective electric cord.

13. The lamp assembly in accordance with claim 12, wherein the lamp cover has a bottom formed with a press plate facing the connecting terminal of the first conducting plate and the connecting terminal of the second conducting plate and rested on the two juxtaposed electric cords to press and squeeze the two juxtaposed electric cords toward the connecting terminals of the first conducting plate and the second conducting plate so that the connecting terminal of the first conducting plate and the connecting terminal of the second conducting plate are penetrated into and electrically connected to the two juxtaposed electric cords.

14. The lamp assembly in accordance with claim 13, wherein the press plate of the lamp cover is located beside and juxtaposed to the receiving grooves of the lamp cover.
